(19) United States
(12) Patent Application Publication
(10) Pub. No.: US 2017/0255747 A1
(43) Pub. Date: Sep. 7, 2017

(54) MEDICAL RECORD OUTPUT SYSTEM AND METHOD

(71) Applicant: Carestream Health, Inc., Rochester, NY (US)

(72) Inventors: Hui Xiang, Shanghai (CN); Song Yang, Shanghai (CN); Yuan Tian, Shanghai (CN)

(21) Appl. No.: 15/350,186

(22) Filed: Nov. 14, 2016

(30) Foreign Application Priority Data
Mar. 1, 2016 (CN) 201610115458.0

(51) Int. Cl. G06F 19/00

(52) U.S. Cl. CPC G06F 19/322

(57) ABSTRACT

The present invention provides a medical record output system, comprising an analysis module for analyzing medical information of a patient to extract identity information indicating an identity of the patient; an output server for acquiring the identity information of the patient from the analysis module, acquiring a medical record of the patient from an image generation apparatus, and matching the identity information of the patient with the medical record of the patient; a memory for storing the matched identity information and medical record; and an output terminal for outputting the matched medical record according to an output request of the patient. A medical record output method is further provided.

### CROSS REFERENCE TO RELATED APPLICATIONS

This application claims priority to CN 201610115458.0 filed on Mar. 1, 2016, incorporated herein in its entirety.

### TECHNICAL FIELD

The present invention relates to a medical technology, and more particularly, the present invention relates to a technology of communication connection with a medical information system for patients to output a medical record.

### BACKGROUND

Currently, a hospital basically manages a series of operations for a patient visiting a doctor or performing an examination in a hospital in an electronic computerization manner. As medical image technologies develop, diagnoses of doctors become increasingly depending on image films of patients. Most hospitals implement printing of image films of patients in a self-service printing manner.

FIG. 1 shows a flow chart of a current system for self-service printing an image film in a hospital. After a technician takes a film for a patient by using an image generation apparatus 13, for example, a medical image generation device such as an X-ray machine, a CT device, an MR device, a DR device, and a CR device, the technician may send a medical image to an output server 17 such as a self-service printing server.

The self-service printing server 17 communicates with a medical information management server 15 such as a PACS, HIS, RIS server, acquires report information of the patient, and then analyzes the report information to extract identity information of the patient. At the same time, the self-service printing server 17 adopts an optical character recognition (OCR) technology to recognize the information of the patient in an electronic film, and extract the identity information of the patient. After the self-service printing server 17 successfully matches the identity information of the patient extracted through the medical information management server 15 with the identity information of the patient in electronic film, an output terminal 21 such as a self-service printing terminal may print and output a medical image film of the patient. Generally, the patient scans his/her label information such as an identity bar code by using a scanner gun of the self-service printing terminal 21, to send a printing output request and print the his/her film.

However, in the conventional printing system of the hospital, in one aspect, in order that the electronic film information of the patient can be found and then printed and output when the patient sends the printing request, the self-service printing server 17 must communicate with the medical information management server 15 to acquire the identity information of the patient. To implement the film printing function, the medical information management server 15 of a third party must open a data interface for the self-service printing server 17. When the self-service printing server 17 and the medical information management server 15 provided by different manufacturers each need to upgrade as required, information asymmetry of the both parties may occur, and therefore, normal work of communication of the data interface cannot be ensured. As a result, when respective server systems are developed and upgraded, it must take other subsystems working together into consideration (for example, related software and/or hardware and the like need to be developed for other subsystems working together), thereby increasing the work load. Meanwhile, they are closely associated with each other, and when one party fails, it may easily lead to incapability of normal working of other subsystems.

In another aspect, when the patient needs an emergency treatment, he/she needs to print his/her medical image film as soon as possible for the doctor to make diagnosis. However, report information of the patient received by the medical information management server 15 needs to be subjected to processes such as creation and checking, and generally reaches the self-service printing server 17 lagging behind the electronic image film; therefore, therefore, when the patient sends the printing request, the self-service printing server 17 cannot acquire the patient report information from the medical information management server 15 in time, and identity information extraction cannot be performed, as a result, a film for printing cannot be output. This greatly affects the efficiency of diagnosis for the patient.

Therefore, to avoid the communication between the self-service printing server and the medical information management server as much as possible and help the patient to accurately print his/her medical image film as quick as possible for subsequent examination, a new printing output system and method are in urgent need to solve the above problems.

### SUMMARY

In view of this, the present invention provides a medical record output system and method, which can solve the above problems. In one aspect, the present invention provides a medical record output system, comprising: an analysis module for analyzing medical information of a patient to extract identity information indicating an identity of the patient; an output server for acquiring the identity information of the patient from the analysis module, acquiring a medical record of the patient from an image generation apparatus, and matching the identity information of the patient with the medical record of the patient; a memory for storing the matched identity information and medical record; and an output terminal for outputting the matched medical record according to an output request of the patient.

According to the medical record output system as described above, the analysis module performs data communication with a medical information management application to receive the medical information of the patient.

According to the medical record output system as described above, the analysis module receives the medical information of the patient from the medical information management application through a virtual printing module.

According to the medical record output system as described above, the analysis module is disposed in the medical information client or the output server.

The medical record output system as described above further comprises a printer in communication with the medical information client, the printer being used for printing label information of the patient, and the output terminal being used for acquiring the printed label information and transmitting the label information to the analysis module.

According to the medical record output system as described above, the label information comprises the identity information of the patient.

According to the medical record output system as described above, the identity information of the patient comprises a name, a registration number, an examination number, a medical card number or a visit number of the patient.

According to the medical record output system as described above, the output terminal is a self-service printing terminal having a printing function.

According to the medical record output system as described above, the memory is disposed in the output server, disposed in the output terminal, disposed outside the output server and the output terminal, or any combination thereof.

According to the medical record output system as described above, the output server comprises an optical character recognition unit for analyzing the medical record received from the image generation apparatus and acquiring the identity information of the patient.

The medical record output system as described above further comprises a printer for printing label information related to the identity of the patient.

In another aspect, the present invention further provides a medical record output method, comprising: a) analyzing medical information of a patient to extract identity information indicating an identity of the patient, and transmitting the identity information to the output server; b) acquiring a medical record of the patient by the output server from an image generation apparatus; c) matching the identity information of the patient with the medical record of the patient by the output server; d) storing the matched identity information and medical record of the patient; and e) outputting a matched medical record according to an output request of the patient.

According to the medical record output method as described above, the analysis module performs data communication with a medical information management application to receive the medical information of the patient.

The medical record output method as described above further comprises printing patient label information received from a medical information client;

recognizing the printed patient label information; and

analyzing the recognized patient label information to acquire the identity information of the patient.

According to the medical record output method as described above, outputting the matched medical record is to present the medical record in a printed manner.

In one aspect, by executing the medical record output system illustrated according to the present invention or adopting the medical record output method, a self-service printing server directly acquires the identity information of the patient from the client without waiting for the medical information of the medical information management server, thereby reducing the dependence of the self-service printing server on the medical information management server. In another aspect, the analysis module provided in the present invention can acquire the identity information of the patient quickly and accurately, and therefore, the probability of incorrectly outputting the medical record by the patient may be reduced.

### BRIEF DESCRIPTION OF THE DRAWINGS

FIG. 1 is a structural schematic diagram of a current system for self-service printing an image film in a hospital;

FIG. 2 is a structural schematic diagram of a medical record output system according to an example of the present invention;

FIG. 3 is another structural schematic diagram of a medical record output system according to an example of the present invention;

FIG. 4 is a still another structural schematic diagram of a medical record output system according to an example of the present invention;

FIG. 5 is a flow chart of a medical record output method according to an example of the present invention; and

FIG. 6 is a method flow chart of step 51 shown in FIG. 5.

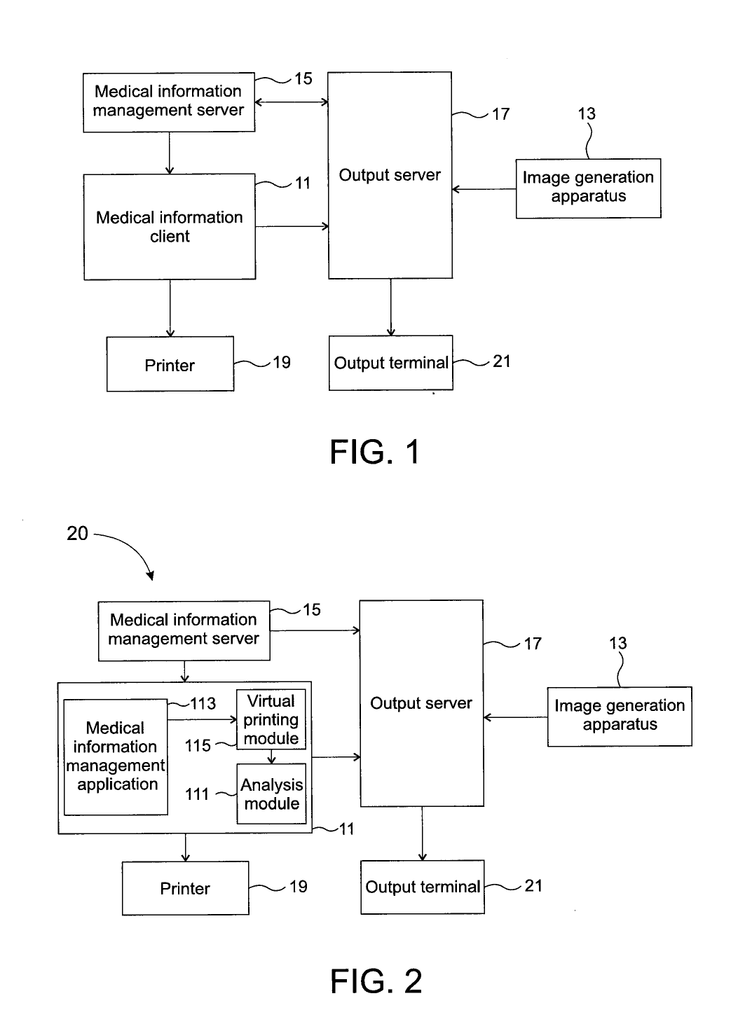

### DETAILED DESCRIPTION

Schematic examples of the present invention are described now with reference to the accompanying drawings, and the same reference numbers represent the same elements. Examples described in the following are helpful for persons skilled in the art to understand the present invention thoroughly, and the examples are intended to be exemplary instead of limiting. The drawings of elements, members, modules, apparatus and device bodies merely illustratively indicate that these elements, members, modules, apparatus and device bodies exist and also indicate relative relations between them, but are not intended to limit their specific shapes. Relationship of the steps in the flow chart is not limited by the given sequence, and it may be adjusted according to an actual application without departing from the protection scope of the present application.

FIG. 2 is a structural schematic diagram of a medical record output system 20 according to an example of the present invention. The medical record output system 20 comprises an analysis module 111, an output server 17, a memory (not shown), and an output terminal 21.

The analysis module 111 is used for analyzing medical information of a patient to extract identity information indicating the identity of the patient. The medical information comprises identity information of the patient, such as ordering information, registration information, hospital guide information and report information. The identity information of the patient may comprise a name, a registration number, an examination number, a medical card number, a visit number on the current day of the patient, or other information that can distinguish the patient from other patients. In some cases, the visit number of the patient on the current day may be a current queuing number. The current queuing number of the patient is an arrangement position of the patient among multiple patients to be inspected, for example, if the queuing number of the patient is 3, it indicates that there are 2 patients to be inspected before the patient. The examination herein may be, for example, taking an X-ray film and the like. The identity information may be information in a character type, a graphics type or the like. To ensure the precision of the identity information, the identity information generally comprises multiple types of data information in the above examples.

The analysis module 111 performs data communication with a medical information management application 113 to receive the medical information of the patient. In an example, the medical information management application 113 is installed in a medical information client 11. Herein, the medical information management application 113 in a hospital for patients generally refers to various electronic systems related to patients in the hospital, such as a hospital information system (HIS), a laboratory management system (LIS), a medical image archive and communication system (PACS), a radiology information system (RIS), an electronic medical record (EMR), and the like.

The medical information management server 15 is in communication connection with one or more medical information clients 11. In an example, the medical information comes from the medical information management server 15. In another example, the medical information may be generated after the identity information of the patient is recorded during ordering and registration, that is, the medical information may come from the medical information management application 113.

In the medical record output system 20 shown in FIG. 2, the analysis module 111 is disposed in the medical information client 11. In this example, the analysis module 111 is an independent module capable of communicating with the medical information management application 113. The analysis module 111 may also be a functional module of the medical information management application 113 on the medical information client 11.

In the example shown in FIG. 2, the analysis module 111 receives the medical information of the patient from the medical information management application 113 through a virtual printing module 115. The virtual printing module 115 is disposed in the medical information client 11. In this example, the communication between the analysis module 111 and the medical information management application 113 occurs inside the medical information client 11.

More specifically, the medical information management application 113 may send the generated medical information or the medical information acquired from the medical information management server 15 to the virtual printing module 115. The virtual printing module 115 converts it into file-type medical information presented on a carrier such as a pdf file, a word file, a txt file or the like. After receiving the file-type medical information, the analysis module 111 analyzes the identity information of the patient.

In an example, the analysis module 111 is used for generating label information of the patient and printing the label information through a printer 19. The printer 19 is communicated with the medical information client 11. The patient may request an output terminal 21 for printing his/her film or report by using the label information. The label information may comprise the identity information of the patient. The analysis module 111 may further generate other prompt information and embody it in the label information to facilitate providing more information for the patient.

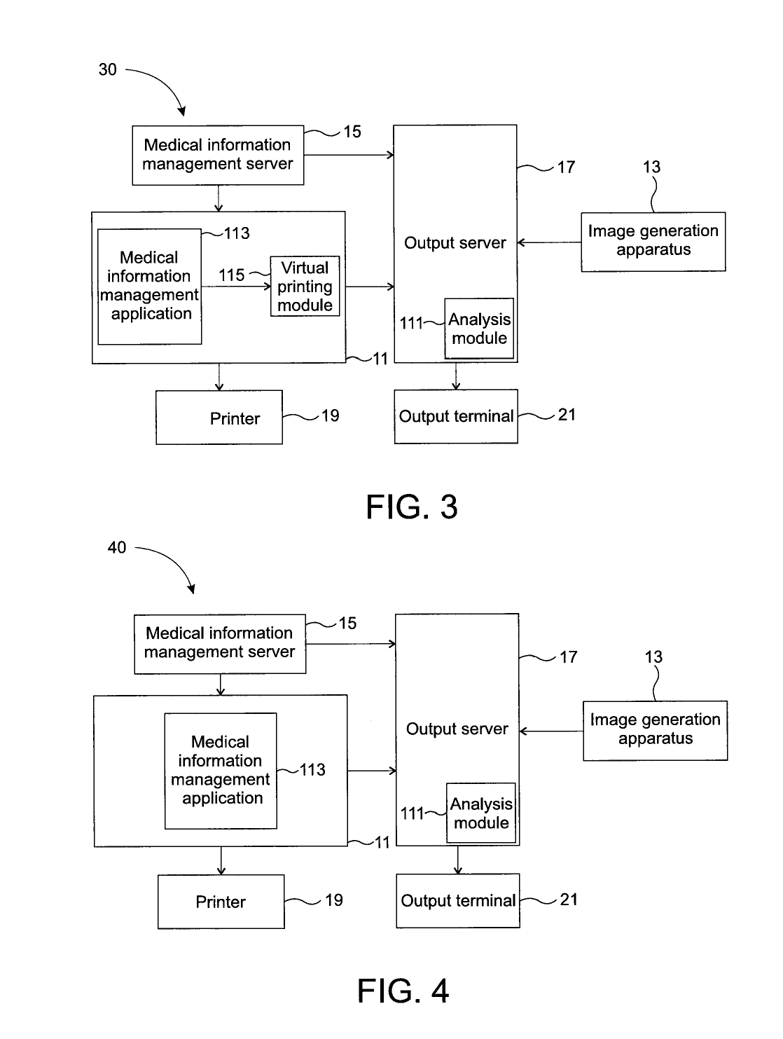

In the medical record output system 30 shown in FIG. 3, the analysis module 111 is disposed in the output server 17. In this example, the analysis 111 may also be a functional module independent of the medical information management application 113 on the medical information client 11.

In the example shown in FIG. 3, the analysis module 111 receives the medical information of the patient from the medical information management application 113 through a virtual printing module 115. The virtual printing module 115 is disposed in the medical information client 11. In this example, the communication between the analysis module 111 and the medical information management application 113 occurs between the output server 17 and the medical information client 11.

More specifically, the medical information management application 113 may send the generated medical information or the medical information acquired from the medical information management server 15 to the virtual printing module 115. The virtual printing module 115 converts it into file-type medical information presented on a carrier such as a pdf file, a word file, a txt file or the like. After receiving the file-type medical information, the analysis module 111 analyzes the identity information of the patient.

In an example, the medical information management application 113 is used for generating label information of the patient and printing the label information through the printer 19. The printer 19 is connected to and communicated with the medical information client 11. The patient may request an output terminal 21 for printing his/her film or report by using the label information. The label information may comprise the identity information of the patient.

In the medical record output system 40 shown in FIG. 4, the analysis module 111 is disposed in the output server 17. In this example, the analysis module 111 is a functional module independent of the medical information management application 113 on the medical information client 11.

In the example shown in FIG. 4, the medical information management application 113 is used for generating label information of the patient and printing the label information through the printer 19. The label information comprises the identity information of the patient, and the patient prints a film or report at the output terminal 21 by using the printed label.

The output terminal 21 is used for acquiring the printed label information and transmitting it to the analysis module 111. More specifically, an information scan apparatus such as a camera disposed on the output terminal 21 scans or photographs the label to re-acquire the identity information of the patient in an electronic format, such as a picture format. The output terminal 21 transmits the re-acquired patient identity information in the electronic format to the analysis module 111. After receiving the patient identity information in the electronic format, the analysis module 111 analyzes the identity information of the patient. In this example, a recognition module based on a recognition technology such as OCR may be disposed in the output terminal as required, for recognizing information in an electronic-format file acquired through the information scan apparatus. It should be noted that, this example requires the technology of disposing the recognition module, and an adopted recognition technology may be determined through the type of the electronic-format file acquired by the information scan apparatus, but the example is not limited to the OCR technology.

The implementation manner shown in FIG. 2, FIG. 3 and FIG. 4 is merely used as an example, and the analysis module 111 is not only limited to be disposed in the medical information client 11 or the output server 17.

The output server 17 acquires the identity information of the patient from the analysis module 111. The identity information acquires a medical record of the patient from an image generation apparatus 13, and matches the identity information of the patient with the medical record of the patient. The output server 17 may comprise a self-service printing server for performing output management on a medical record such as a medical image film and a report of the patient. The image generation apparatus 13 comprises a medical image generation device for the patient, such as an X-ray machine, a CT device, an MR device, a DR device, and a CR device.

The memory is used for storing the matched identity information and medical record. The memory is disposed in the output server 17, disposed in the output terminal 21, disposed outside the output server 17 and the output terminal 21, or any combination thereof. In the case where the output server 17 or the output terminal 21 has had a storage member, a memory may not be additionally disposed, and definitely, if the storage member of the output server 17 or the output terminal 21 is insufficient for storage, a memory may be disposed externally.

The output terminal 21 outputs a matched medical record according to an output request of the patient. According to some examples of the present invention, the output terminal 21 may be a self-service printing terminal having a printing function, and in this case, the patient may print his/her medical record through the output terminal 21. In this example, the output server 17 may match the to-be-printed medical record with an appropriate carrier, to facilitate selection of a suitable carrier by the output terminal 21 during printing. Herein, the medical record may be various types of medical-related records that can be output, such as examination results, medical image films, and doctor diagnosis illustration.

The following example is illustrated with reference to FIG. 2, and a PACS and/or RIS is used as a medical information system in a hospital for a patient to illustrate the core of the present invention; however, it is not intended to limit the present invention to merely the PACS and/or RIS. Here, it should be noted that, the PACS and/or RIS comprises the following situations: merely the PACS, merely the RIS, the PACS and the RIS are integrated together, and the PACS and the RIS are independent to each other but are mounted in the same electronic device (for example, a server). No matter which case the PACS and/or RIS is, the application of the present invention therein is not affected.

In the following example, the medical information management server 15 is a PACS and/or RIS server, the medical information client 11 is an RIS client, the output server 17 is a self-service printing server, and the output terminal 21 is a self-service printing terminal.

In an example, after the patient accomplishes ordering or registration at the RIS client 11, the RIS client 11 stores corresponding patient medical information, such as identity information. In another example, the medical information management server 15 may send the medical information of the corresponding patient such as an examination report to the RIS client 11. The analysis module 111 analyzes the medical information of the patient to extract the identity information indicating the identity of the patient. As an example, the identity information comprises a name, a registration number, and an examination number of the patient. The analysis module 111 only needs to recognize the medical information of the patient output by the medical information management application 113 through the virtual printing module 115, so as to extract characters and numbers of the patient identity information in the medical information. The medical information of the patient output by the virtual printing module 115 may be presented as patient information stored in a carrier such as a pdf file, a word file, a txt file or the like. The precision of the analysis and extraction technologies of characters and numbers in the electronic files is very high, so as to reduce the error rate of extracting the patient identity information. Then, the analysis module 111 sends the identity information to the self-service printing server 17.

As shown in FIG. 2, the RIS client 11 prints label information related to the patient identity through the printer 19. The label information may be in a form of a bar code and/or characters. By means of the label information, the patient may go to the corresponding self-service printing terminal 21 to recognize the label information by using a scanner gun, and then request for printing his/her medical record. In an example, the printer 19 may further be used for printing other medical information of the patient, such as an ordering form, a registration form, and a hospital guide form.

The patient goes to a corresponding department to take a film according to the hospital guide form or a doctor instruction, and a technician takes a film for the patient through the image generation apparatus 13 and then sends the medical image information to the self-service printing server 17. After that, for facilitating subsequent diagnosis, the patient needs to print his/her medical image film at the self-service printing terminal 21. In an example, the patient may scan a bar code of his/her label information through the self-service printing terminal 21 to send a film printing request. The film printing request is sent to the self-service printing server 17 via the self-service printing terminal 21.

The self-service printing server 17 adopts an optical character recognition (OCR) technology to recognize the information of the patient in the electronic film, and extract the identity information of the patient. After the self-service printing terminal 17 receives the precise identity information extracted by the analysis module 111 of the RIS client 11, the self-service printing terminal 17 needs to respectively compare various data in the identity information of the analysis module 111 with corresponding data in the identity information extracted through the OCR technology. After the matching succeeds, the matched identity information and the medical film may be both stored in the self-service printing server 17.

After the patient sends a printing request through scanning or inputting two-dimensional code information in the label information by the self-service printing terminal 21, the self-service printing terminal 21 may print and output the medical image film of the corresponding patient.

In the medical record output system according to the present invention described in combination with FIG. 2, FIG. 3 or FIG. 4, in one aspect, the self-service printing server 17 can directly obtain the patient identity information through the analysis module 111 provided in this example without communicating with the PACS and/or RIS server 15. It is unnecessary to develop corresponding interfaces for the output server 17 and the PACS and/or RIS server 15, so as to save the cost, and meanwhile, it is unnecessary to wait for the medical information of the patient in the PACS and/or RIS server 15, thereby reducing the dependence of the medical record output system on the PACS and/or RIS. In another aspect, the patient identity information may be quickly acquired through the analysis function of the analysis module 111. The self-service printing server 17 may match the identity information with the medical image information acquired from the image generation apparatus 13. When the patient proposes an image film printing request at the self-service printing terminal 21, the self-service printing server 17 may quickly and precisely output/print the medical image film of the patient.

In the present invention, the “communication connection” refers to connection in a communication manner. The connected parties may perform communication therebetween by means of wire connection such as cables; the connected parties may perform communication therebetween by means of wireless communication; or the connected parties may perform communication therebetween by means of wireless communication as well as wire connection such as cables.

According to an example of the present invention, a medical record output method 50 is further provided. The method is executed in an environment comprising an electronic system, an output server and an output terminal for patients in a hospital. As an example, the environment is, for example, a medical record output system in communication connection with the PACS and/or RIS shown in FIG. 2.

According to the method 50, at step 51, medical information of a patient is analyzed to extract identity information indicating an identity of the patient, and the identity information is transmitted to the output server. At step 53, the output server acquires a medical record of the patient from an image generation apparatus. At step 55, the output server matches the identity information of the patient with the medical record of the patient. At step 57, the matched identity information and medical record are stored. At step 59, a matched medical record is output according to an output request of the patient.

At the step 51, in an example, the analysis module performs data communication with a medical information management application installed in the medical information client to receive the medical information of the patient.

In another example, the step 51 schematically and non-limitedly further comprises the method shown in FIG. 6. As shown in FIG. 6, at step 61, patient label information received from a medical information client is printed. At step 63: The printed patient label information is recognized. At step 65: The identified patient label information is analyzed to acquire identity information of the patient.

In the step 59, the outputting is to present a medical record in a printing manner.

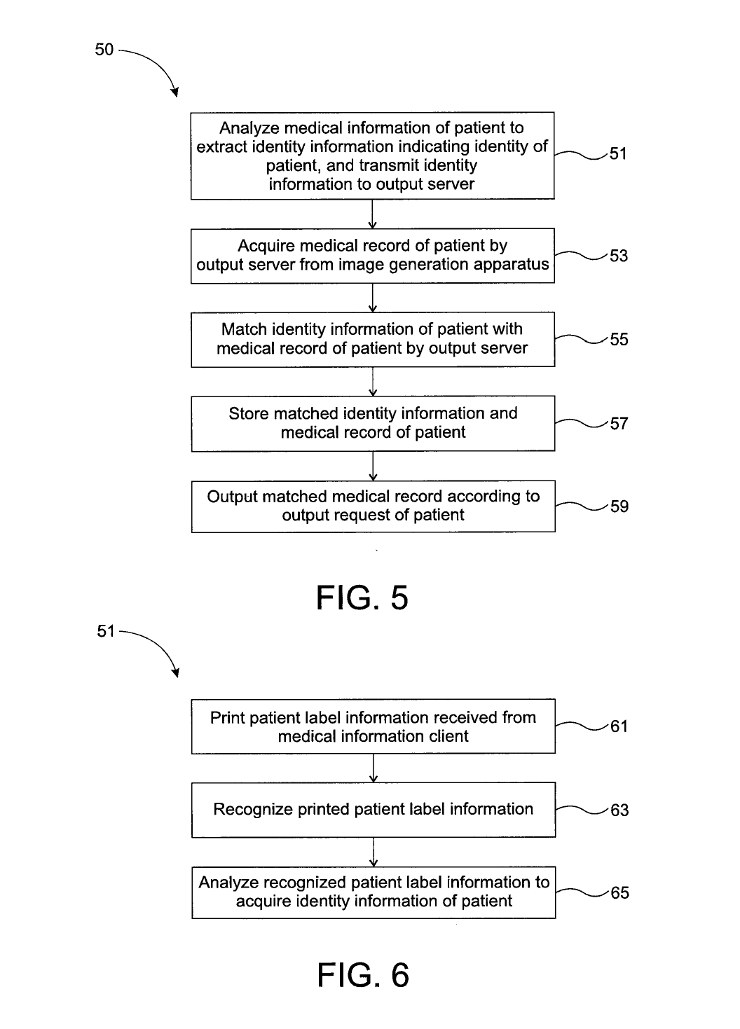

FIG. 5 and FIG. 6 are flow charts of a medical record output method according to an example of the present invention, and herein, the method is described illustratively and non-limitedly in combination with the medical record output system in communication connection with the PACS and/or RIS shown in FIG. 2, FIG. 3 or FIG. 4.

The specific embodiments of the present invention have been disclosed in above descriptions in combination with the accompanying drawings; however, persons skilled in the art may understand that variations or modifications can be made on the disclosed specific embodiments without departing from the spirit of the present invention. The embodiments of the present invention are merely used for schematically illustrating instead of limiting the present invention.

1. A medical record output system, comprising:
an analysis module for analyzing medical information of a patient to extract identity information indicating an identity of the patient;
an output server for acquiring the identity information of the patient from the analysis module, acquiring a medical record of the patient from an image generation apparatus, and matching the identity information of the patient with the medical record of the patient;
a memory for storing the matched identity information and medical record; and
an output terminal for outputting the matched medical record according to an output request of the patient.

2. The medical record output system according to claim 1, wherein the analysis module performs data communication with a medical information management application to receive the medical information of the patient.

3. The medical record output system according to claim 2, wherein the analysis module receives the medical information of the patient from the medical information management application through a virtual printing module.

4. The medical record output system according to claim 2, wherein the analysis module is disposed in a medical information client or the output server.

5. The medical record output system according to claim 1, further comprising a printer in communication with the medical information client, the printer being used for printing label information of the patient, and the output terminal being used for acquiring the printed label information and transmitting the label information to the analysis module.

6. The medical record output system according to claim 5, wherein the label information comprises the identity information of the patient.

7. The medical record output system according to claim 1, wherein the identity information of the patient comprises a name, a registration number, an examination number, a medical card number or a visit number of the patient.

8. The medical record output system according to claim 1, wherein the output terminal is a self-service printing terminal having a printing function.

9. The medical record output system according to claim 1, wherein the memory is disposed in the output server, disposed in the output terminal, disposed outside the output server and the output terminal, or any combination thereof.

10. The medical record output system according to claim 1, wherein the output server comprises an optical character recognition unit for analyzing the medical record received from the image generation apparatus and acquiring the identity information of the patient.

11. The medical record output system according to claim 1, further comprising a printer for printing label information related to the identity of the patient.

12. A medical record output method, comprising:
a) analyzing medical information of a patient to extract identity information indicating an identity of the patient, and transmitting the identity information to the output server;
b) acquiring a medical record of the patient by the output server from an image generation apparatus;
c) matching the identity information of the patient with the medical record of the patient by the output server;
d) storing the matched identity information and medical record of the patient; and
e) outputting a matched medical record according to an output request of the patient.

13. The medical record output method according to claim 12, wherein the analysis module performs data communication with a medical information management application to receive the medical information of the patient.

14. The medical record output method according to claim 12, further comprising printing patient label information received from a medical information client;
recognizing the printed patient label information; and
analyzing the recognized patient label information to acquire the identity information of the patient.

15. The medical record output method according to claim 12, wherein outputting the matched medical record is to present the medical record in a printed manner.
